(19) United States
(12) Patent Application Publication
(10) Pub. No.: US 2015/0343627 A1
(43) Pub. Date: Dec. 3, 2015

(54) Wrench

(71) Applicant: Charles Hensley, Stanford, KY (US)

(72) Inventor: Charles Hensley, Stanford, KY (US)

(21) Appl. No.: 14/725,948

(22) Filed: May 29, 2015

Related U.S. Application Data
(60) Provisional application No. 62/004,515, filed on May 29, 2014.

(51) Int. Cl. B25G 1/04; B25B 23/16; B25B 23/00

(52) U.S. Cl. CPC B25G 1/043; B25B 23/0035; B25B 23/16

(57) ABSTRACT

The present invention provides a wrench configured to allow a user to apply torque to nuts or bolts in tight spaces. The wrench includes a plurality of pieces that are removably attached including at least one handle shaft, at least one attachment shaft and at least two heads. The plurality of pieces are removably attached via fasteners. Each fastener includes a male adapter configured to removably attach to a female adapter via a ball detent mechanism. Preferably, the male adapter is a square protrusion, while the female adapter is a star-shaped aperture configured to receive the male adapter in a variety of angles. In one configuration, the plurality of pieces are removably attached to one another to form a Z-shape. In this way, a user can apply torque to nuts or bolts in tight spaces.

### CROSS REFERENCE TO RELATED APPLICATION

This application claims the benefit of U.S. Provisional Application No. 62/004,515 filed on May 29, 2014. The above identified patent application is herein incorporated by reference in its entirety to provide continuity of disclosure.

### FIELD OF THE INVENTION

The present invention relates to tools. Specifically, the present invention relates to a wrench that allows a user to more easily apply torque to a nut or bolt that is located in tight or awkward spaces. The wrench includes a plurality of removably attached pieces that can provide multiple configurations for applying torque in tight spaces.

### BACKGROUND OF THE INVENTION

Wrenches are used to provide grip to allow a user to apply torque to nuts and bolts to either tighten or loosen the same. There are a variety of wrenches, which include adjustable, box end, open end, combination, socket, and Allen wrenches. Adjustable wrenches are designed so that a user can apply pressure on both the fixed and movable jaws. An open end wrench is a nonadjustable wrench that comes in a variety of jaw sizes. Furthermore, a combination wrench includes an open end wrench on one end of the wrench and the second end of the wrench includes a box wrench. Both ends generally fit the same size nut and bolt.

These conventional wrenches, however, are very difficult to use with nuts and bolts in tight spaces or awkwardly shaped spaces. It is often problematic for a user to apply proper torque in these situations in order to tighten or loosen these nuts and bolts. Therefore, there exists a need for a new and improved wrench that allows a user to apply the necessary torque to tighten or loosen nuts and bolts in tight or awkward spaces.

Devices have been disclosed in the prior art that relate to wrenches and adjustable wrenches. These include devices that have been patented and published in patent application publications. But, these devices disclosed in the prior art have several known drawbacks. Some of these devices provide lengthwise adjustable wrenches that are adjusted by a ratcheting mechanism. Other devices provide an extendable ratchet wrench having a pair of sections that are lockable in relation to one another. These devices, however, fail to provide a plurality of pieces that extend the length of the wrench, wherein the wrench also includes a crow's foot head.

The present invention provides a wrench configured to allow a user to apply torque to nuts or bolts in tight or awkward spaces. The wrench includes a plurality of pieces that are removably attached including at least one handle shaft, at least one attachment shaft and at least two heads. The plurality of pieces are removably attached via fasteners. Each fastener includes a male adapter configured to removably attach to a female adapter via a ball detent mechanism. Preferably, the male adapter is a square protrusion, while the female adapter is a star-shaped aperture configured to receive the male adapter in a variety of angles. In one configuration, the plurality of pieces are removably attached to one another to form a Z-shape. In this way, a user can uniquely apply torque to nuts or bolts in tight spaces.

It is therefore submitted that the present invention is substantially divergent in design elements from the prior art, and consequently it is clear that there is a need in the art for an improvement to wrenches. In this regard, the instant invention substantially fulfills these needs.

### SUMMARY OF THE INVENTION

In view of the foregoing disadvantages inherent in the known types of wrenches now present in the prior art, the present invention provides a new and improved wrench wherein the same includes a plurality of pieces that are removably attached to one another to allow a user to apply torque to nuts or bolts in awkward spaces.

It is therefore an object of the invention to provide a new and improved wrench that has all of the advantages of the prior art and none of the disadvantages.

Another object of the present invention is to provide a new and improved wrench comprising a plurality of pieces that are removably attached to one another to allow a user to apply torque to nuts and bolts that are in tight or awkward spaces.

Yet another object of the present invention is to provide a new and improved wrench, wherein the plurality of pieces include at least one attachment shaft, at least one handle shaft, and at least two heads.

Still yet another object of the present invention is to provide a new and improved wrench, wherein the plurality of pieces are removably attached to one another via fasteners.

A further object of the present invention is to provide a new and improved wrench, wherein each said fastener includes a male adapter removably attached to a female adapter via a ball detent mechanism.

Yet a further object of the present invention is to provide a new and improved wrench, wherein one configuration includes a pair of handle shafts attached orthogonally to one another to substantially form a Z-shape.

Still yet another object of the present invention is to provide a new and improved wrench wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an overhead perspective of the present invention.

FIG. 2 shows an overhead perspective of the plurality of pieces of the present invention detached from one another.

FIG. 3 shows a perspective view of the fastener of the present invention configured to removably attach the crow's foot head to the handle shaft.

FIG. 4 shows a perspective view of the fastener of the present invention configured to removably attach the handle shaft to the ring spanner head.

FIG. 5 shows a side perspective of a Z-shaped configuration of the present invention.

### DETAILED DESCRIPTION OF THE INVENTION

Reference is made herein to the attached drawings. Like reference numerals are used throughout the drawings to depict like or similar elements of the wrench. For the purposes of presenting a brief and clear description of the present invention, the preferred embodiment will be discussed as used for applying torque to a nut or a bolt that is in an awkward or tight space. The figures are intended for representative purposes only and should not be considered to be limiting in any respect.

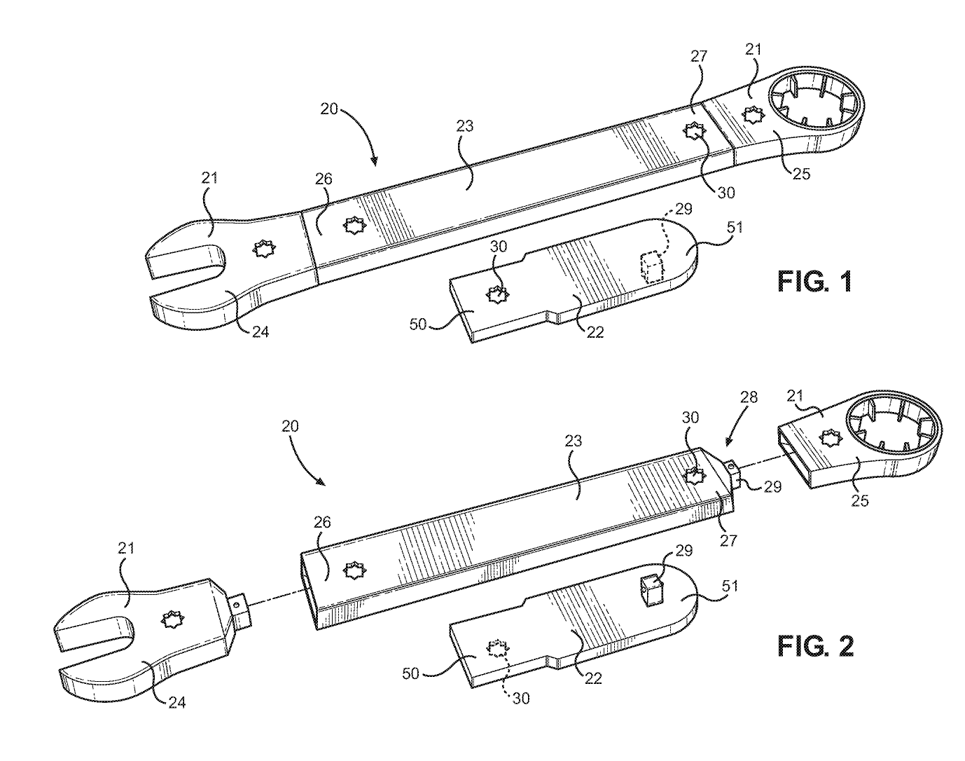

Referring now to FIGS. 1 and 2, there are shown a pair of overhead perspectives of the wrench 20. Specifically, FIG. 1 shows the wrench 20 and its plurality of pieces removably attached together, while FIG. 2 shows the plurality of pieces of the wrench detached from one another. The wrench 20 is configured to allow a user to use the wrench 20 in tight and awkward spaces by providing a wrench 20 that includes a plurality of pieces that are removably attached, which allow the wrench 20 be rearranged at different angles to apply additional torque, especially in close corridors. The wrench 20 includes a plurality of pieces comprising at least two heads 21, at least one attachment shaft 22, and at least one handle shaft 23. As illustrated, the at least two heads 21 includes a crow's foot head 24 and a ratchet ring spanner head 25. The wrench 20 in FIG. 1 is attached in a conventional configuration that resembles a conventional wrench.

The crow's foot head 24, as illustrated, includes a pair of spaced apart rigid jaws, which define a nut-receiving mouth, wherein the crow's foot head 24 is configured to apply or remove a nut or bolt by means of manual rotation through the handle shaft 23. The ratchet ring spanner head 25, as illustrated, includes a circular peripheral wall, which defines a receiving compartment therein for receiving a ratchet wheel therein. Furthermore, both the crow's foot head 24 and the ratchet ring spanner head 25 are configured to attach to the handle shaft 23 via a fastener. It is contemplated that a plurality of crow's foot heads having varying mouth sizes and a plurality of ratchet ring spanner heads having varying receiving compartments can be removably attached to achieve the advantages described herein. It is also anticipated that those of ordinary skill in the art will readily envision a variety of other types of tool heads that may be suitable for the wrench 20, these variations and modifications are deemed within the scope and spirit of the present invention, and likewise contemplated.

The handle shaft 23 includes a first end 26 and a second end 27, wherein each end 26, 27 are configured to support and removably attach a head 24, 25 via the fastener 28. Preferably, the fastener 28 includes a ball detent mechanism and male and female adapters 29, 30. The fastener 28 is particularly advantageous because the male and female adapters 29, 30 allow for each head 24, 25, the handle shaft 23, and the connection shaft 22 to be removably attached to one another at a multitude of angles and enables the tool to form multiple shapes.

The attachment shaft 22 is substantially shorter in length than the handle shaft 23. The attachment shaft 22 includes a distal end 50 and a proximal end 51. The proximal end 51 includes a male adapter 29, and the distal end 50 includes a female adapter 30. The male adapter 29 and the female adapter 30 of the attachment shaft 22 are located on opposite faces of the attachment shaft 22. Furthermore, the head 25 includes a pair of female adapters 30. In this way, the wrench 20 can be removably attached in several configurations to allow a user to apply torque to a nut or bolt in awkward spaces. More particularly, the attachment shaft 22 extends the wrench 20 away from awkward spaces. In doing so, the wrench 20 can apply the necessary torque in these tight spaces.

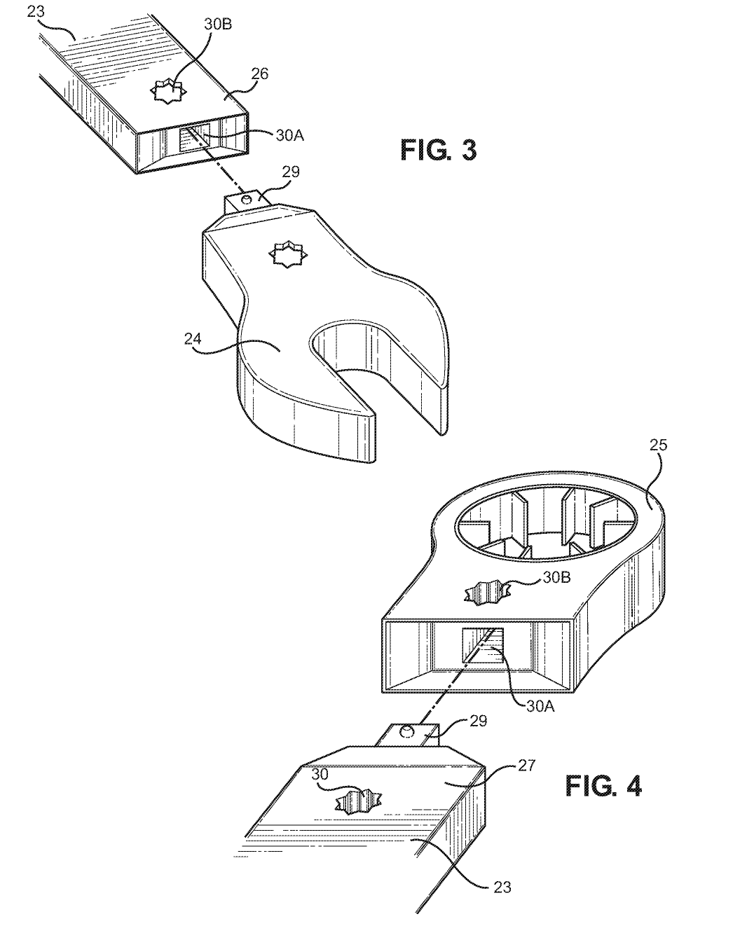

Referring now to FIG. 3, there is shown a perspective view of the fastener 28. As exemplified, the head 24 includes a male adapter 29 and a female adapter 30. In this way, the head 24 can be removably attached to a handle shaft 23 or the attachment shaft can be removably attached by securing a male adapter 29 to the female adapter 30A, 30B. Additionally, the first end 26 includes a pair of female adapters 30A, 30B, which allow a head 24 or an attachment shaft to be attached either in a singular plane or orthogonal thereto.

Referring now to FIG. 4, there is shown a perspective view of the fastener 28. The second end 27 of the handle shaft 23 includes a male adapter 29 that is a squared-shaped protrusion that is configured to be removably fastened to the female adapter 30 of the head 25 via the ball detent mechanism. The head 25 includes a pair of female adapters 30A, 30B, wherein one of the female adapters 30A is a square shaped aperture and the other female adapter 30B is a star-shaped aperture that is configured to receive and removably fasten the male adapter 29 therein. The square shaped aperture is configured to receive a male adapter 29 to form a conventional wrench. In addition, the male adapter 29 is configured to be rotated at 45 degree increments and aligned with the female adapter 30B that is star-shaped. In this way, the handle shaft 23 can be attached at different angles to the head 25 allowing a user to apply additional torque to a nut or bolt in tight and awkward spaces as needed.

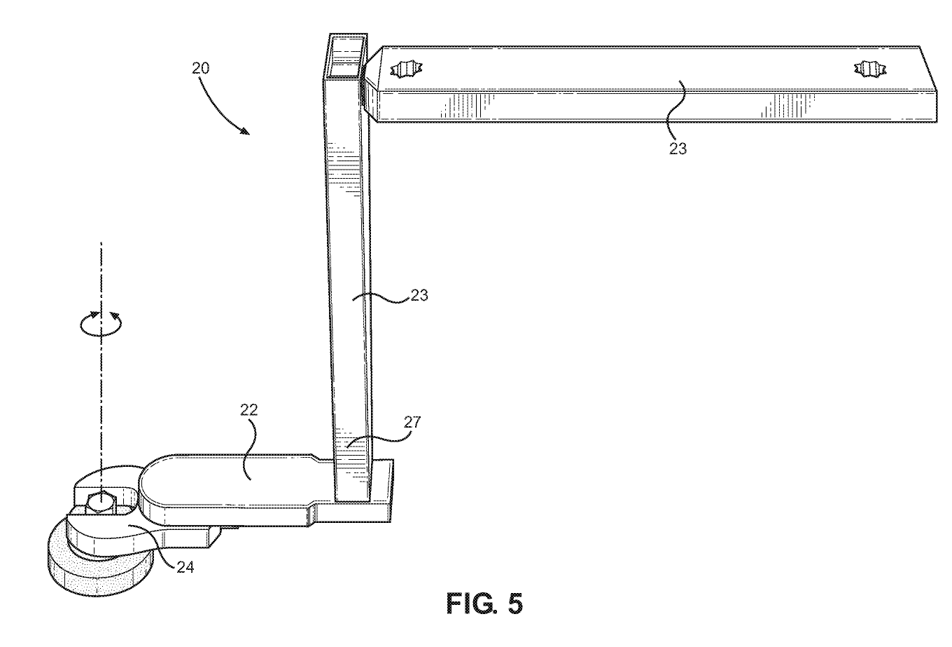

Referring now to FIG. 5, there is shown a side perspective of one configuration of the wrench 20. In this specific illustrated configuration, the wrench 20 includes a pair of handle shafts 23 removably attached to one another. The pair of handle shafts 23 are removably attached to one another in a perpendicular configuration by the fastener. The second end 27 of one of the handle shafts 23 is removably attached to the attachment shaft 22 in an orthogonal manner. The attachment shaft 22 is removably attached to the head 24 in a coplanar manner. As illustrated, the wrench 20 in this configuration substantially forms a Z-shape. This configuration of the wrench 20 is particularly advantageous as it allows a user to apply torque to a nut or bolt in tight spaces in a unique manner.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wrench, comprising:
a plurality of pieces that are removably attachable to form a wrench;
wherein said plurality of pieces includes at least one handle shaft, at least one attachment shaft, and at least two heads;
wherein said at least one handle shaft is configured to be removably attached to said at least one attachment shaft and/or said at least two heads via fasteners;
said fasteners each include a ball detent mechanism and a male adapter configured to removably attach to a female adapter.

2) The wrench of claim 1, wherein said male adapter includes a square-shaped protrusion configured to removably attach to said female adapter via said ball detent mechanism.

3) The wrench of claim 1, wherein:
said female adapter includes a star-shaped aperture configured to removably attach said male adapter via said ball detent mechanism;
wherein said male adapter is configured to rotate 45 degrees to removably attach to said female adapter at different angles.

4) The wrench of claim 1, wherein:
said female adapter includes a square-shaped aperture configured to removably attach said male adapter via said ball detent mechanism.

5) The wrench of claim 1, wherein:
said at least one handle shaft each include a first end and a second end;
wherein each said first end and said second end is configured to removably fasten one of said plurality of pieces thereto.

6) The wrench of claim 1, wherein said at least two heads includes a crow's foot head and a ratchet ring spanner head.

7) The wrench of claim 1, wherein said first end of said at least one handle shaft includes a pair of said female adapters each configured to align with one of said male adapters.

8) The wrench of claim 1, wherein said second end of said at least one handle shaft includes said male adapter and said female adapter to allow said second end to be orthogonally attached to one of said plurality of pieces or attached in a singular plane.

9) The wrench of claim 1, wherein:
said at least one attachment shaft each includes a proximal end and a distal end;
wherein said proximal end includes said male adapter and said distal end includes said female adapter;
wherein said male adapter and said female adapter of said at least on attachment shaft are located on opposite faces of said at least one attachment shaft.

10) The wrench of claim 1, wherein one of said at least two heads includes said male adapter and said female adapter.

11) The wrench of claim 1, wherein said one of said at least two heads includes a pair of said female adapters.

12) The wrench of claim 1, wherein said at least one handle shaft includes a pair of handle shafts orthogonally attached to one another via said fastener.

13) The wrench of claim 12, wherein said at least one attachment shaft is orthogonally attached to one of said pair of attachment shafts via said fastener.

14) The wrench of claim 13, wherein one of said heads is attached in a coplanar manner to said at least one attachment shaft.
